(19) United States
(12) Patent Application Publication
(10) Pub. No.: US 2021/0394487 A1
(43) Pub. Date: Dec. 23, 2021

(54) LAMINATED GLASS PANE AND METHOD FOR THE PRODUCTION THEREOF

(71) Applicant: SAINT-GOBAIN GLASS FRANCE, COURBEVOIE (FR)

(72) Inventors: Gabor VARGA, HERZOGENRATH (DE); Bastian KLAUSS, HERZOGENRATH (DE); Michael ZEISS, HERZOGENRATH (DE); Christian EFFERTZ, AACHEN (DE)

(21) Appl. No.: 17/279,363

(22) PCT Filed: Sep. 6, 2019
(86) PCT No.: PCT/EP2019/073797

§ 371 Date: Mar. 24, 2021

(30) Foreign Application Priority Data
Sep. 25, 2018 (EP) 18196454.5

(51) Int. Cl. B32B 17/10; B32B 3/08; B60J 1/00

(52) U.S. Cl. CPC B32B 17/10036; B32B 17/10541; B32B 17/10293; B32B 17/10761; B32B 2605/006; B60J 1/001; B32B 2250/03; B32B 2250/40; B32B 2307/732; B32B 3/08

(57) ABSTRACT

A laminated glass pane includes two glass or polycarbonate panes and at least one polymer film or a film laminate bonded therebetween and an electronic functional unit arranged therebetween, wherein, in part of the area of the laminated glass pane, a cutout of the polymer film or of the film laminate is provided and, accommodated in the cutout, is a fully prefabricated electronic functional module including multiple electronic functional units and/or other parts that are arranged within the functional module laterally alongside one another and/or at least partially vertically overlapping in an electrically and mechanically protective insulating shell, in particular an encapsulation composed of a polymeric casting compound that has a thickness that is at most equal to the thickness of the polymer film or of the film laminate.

The invention relates to a laminated glass pane comprising two glass or polycarbonate panes and at least one polymer film or a film laminate bonded therebetween and an electronic functional unit arranged therebetween. It further relates to a method for producing such a laminated glass pane.

In motor vehicles and in buildings, the detection of conditions or parameters of the environment plays an increasingly important role for safe and efficient operation. Modern passenger cars as well as high quality buildings are, consequently, equipped with a large number of sensors that detect relevant environmental conditions or parameters and deliver the current values to processing and control units that control functions of the vehicle or building. Incidentally, this applies not only to motor vehicles but also, to a certain extent, to certain watercraft.

Certain sensors can advantageously be accommodated on or in the front window or, optionally, also the rear window or a glass roof unit of a passenger car. Such arrangements have long been known for so-called rain sensors, via which the window wiper functions of the vehicle are controlled. Within the context of the general trend toward largely complete prefabrication of vehicle components, there are developments aimed at integration of such sensors into a prefabricated glazing unit (such as the front or rear window) of a vehicle. Corresponding solutions are mentioned in the unpublished European patent application No. 17192877.3.

Vehicle windows with integrated or partially integrated sensors are also known from EP 2 121 308 B1 or CN 101 087 135 A. Known from DE 10 2004 054 465 A1 is an optical moisture sensor for detection of moisture on the outside and/or the inside of a motor vehicle window, which is integrated into the PVB film with which the two panes of the laminated glass pane are joined to one another. Furthermore, known from WO 2015/162107 A1 is a glass panel with an illuminated switching surface and heating function.

According to the prior art, electronic functional units and their supply lines are integrated into the laminated glass pane in each case in the so-called in-line process, i.e., during the bonding of the two panes with the polymer film (PVB film) position therebetween. This imposes time limits on the bonding process, which can basically be carried out at high speed, resulting from the specifics of the respective components, electrical supply lines, etc., and leading to a considerable reduction in the productivity of the bonding process (in-line process).

The object of the invention is, consequently, to specify an improved laminated glass pane as well as an improved method for its production that enable efficient production with high throughput and correspondingly low costs.

This object is accomplished in its device aspect by a laminated glass pane with the features of claim 1 and in its method aspect by a method with the features of claim 9. Expedient further developments of the concept of the invention constitute the subject matter of the respective dependent claims.

The invention includes the idea of combining the electronic functional units and, optionally, other parts to be accommodated in a laminated glass pane equipped with electronics or sensors to form a prefabricated electronic functional module and to introduce this into the in-line process mentioned together with the polymer film or the film laminate, and to process them together in the in-line process with the usual throughput for this process. It further includes the idea of providing, in part of the area of the laminated glass pane, a cutout of the polymer film or the film laminate, which cutout corresponds to the lateral dimensions of the functional module. In addition, it is necessary for the functional module to be produced with a thickness that is at most equal to the thickness of the polymer film or of the film laminate, such that the in-line process can run with the polymer films or film laminates customarily used therein.

In the context of the present invention, the term “electronic functional module” is to be understood in a broad sense which includes a sensor module (for example, a rain or humidity or even a light sensor module), a display module (for example, a head-up display module in the front window), a communication module (for example, antenna or integrated radio module) as well as combinations of the functional units mentioned with each other or with other functional units not mentioned here.

The electronic functional module includes multiple electronic functional units and/or other parts that are arranged laterally alongside one another and/or at least partially vertically overlapping within the functional module.

The electronic functional module further includes an encapsulation made of a suitable plastic material insulatingly encapsulating and electrically and mechanically protecting the electrical and electronic parts. This can, in particular, be a casting compound that is known and proven for such purposes.

The invention achieves the substantial advantage that the limitations of productivity and associated cost increases that until now have inevitably accompanied the integration of sensors and other electronic functional elements or structures into a composite glass pane can be overcome. In addition, the very extensive combination of the corresponding elements and structures into a closed functional module enables its independent pre-testing and, thus, timely culling of defective functional units before their incorporation into an expensive end product. Furthermore, as a result of the invention, a change in the technology of the in-line process due to technical changes in the electronic functional units can largely be avoided because such changes are implemented within the electronic functional module and typically have no influence on the external shape of the functional module.

In implementations currently considered particularly significant economically, the composite glass pane according to the invention is implemented as a front window or rear window or roof glazing of a vehicle, wherein the cutout of the polymer film or the film laminate and the prefabricated electronic functional module are arranged at or near an edge of the composite glass pane. Large-scale use in road vehicles, in particular in passenger cars, should be emphasized here. However, use in other vehicles, such as boats, small aircraft, air taxis, and the like, is also possible. In addition to use of the invention in vehicles, use in building glazing can also be beneficial.

In accordance with established technologies of producing laminated glass panes specifically for road vehicles, in preferred embodiments of the invention, the thickness of the polymer film or of the film laminate and of the electronic functional module is less than 1.2 mm and in particular in the range between 0.6 mm and 1.0 mm. it goes without saying that the invention can also beneficially be used in connection with thicker polymer films or film laminates, in which case the accommodation of multiple functional elements in a single functional module can be simplified in terms of the electrical parameters and the connection and encapsulation technology.

In another embodiment preferred under current considerations, the electronic functional module has the shape of a flat prism, in particular of a flat cuboid, or of a flat circular disk. In particular, the two main surfaces of the flat prism or of the flat circular disk can be coated with adhesive for gluing the electronic functional module between the glass or polycarbonate panes. In principle, it is possible to dispense with adhesive coating of the functional module provided that secure integration into the laminated glass pane and compliance with the requirements imposed on the mechanical properties are insured even without such adhesive bonding.

In implementations currently considered significant, the electronic functional module includes at least one of the following functional units: a moisture sensor, a light sensor, a temperature sensor, an antenna, an actuator, an electronic processing or switching unit, an LCD display unit, and an LED display unit. In particular, more than one functional unit from this group can be included, in which case the advantages of modular prefabrication become particularly obvious.

The advantages of the invention are just as pronounced in other embodiments, in which the fully prefabricated electronic functional module includes an integrally prefabricated electrical supply line that is accommodated, in particular, in a supply line cutout of the polymer film or of the film laminate. In principle, the functional module can also be provided with multiple integrated supply lines provided this makes sense in the interest of optimal functioning.

Method aspects of the invention are largely evident from the device aspects explained above and are, consequently, not explained again here. It is, however, pointed out that the steps of the method specified in claim 9 as well as its configuration can be modified to the extent specific embodiments of the electronic functional module provided according to the invention make it seem reasonable. It is essential here that the advantages of the prefabrication of the electronic functional units are actually realized for the highly productive process of the joining of the individual panes with a polymer film or a film laminate.

Advantages and practicalities of the invention are also evident from the following description of exemplary embodiments with reference to the figures. They depict:

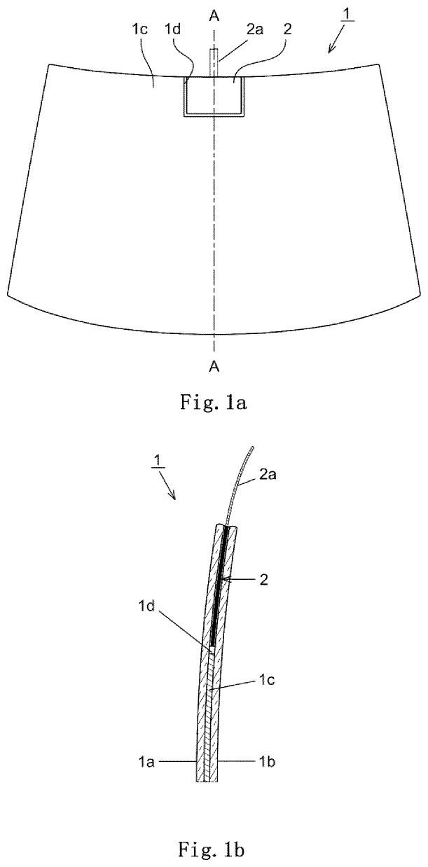

FIG. 1a and 1b schematic representations (plan view and sectional view) of an exemplary embodiment of the invention and

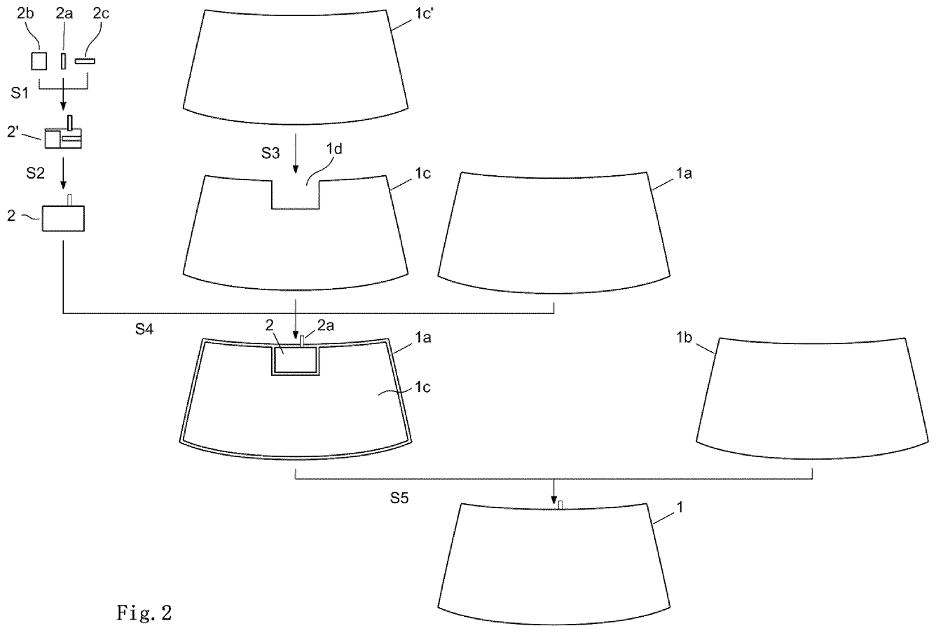

FIG. 2 a schematic representation to explain the method according to the invention.

FIG. 1a schematically depicts a plan view of a passenger car front window 1 in accordance with an exemplary embodiment of the invention, and FIG. 1b depicts a sectional view of the same, along a sectional plane A-A. The front window 1 is formed as a laminated glass pane with a first and second glass pane 1a, 1b and a polymer film 1c bonded between the glass panes. In a region near the upper edge of the front window, a cutout 1d is provided in the polymer film 1c, in which cutout an electronic functional module 2 is inserted between the first and second glass pane 1a, 1b. The functional module 2 includes a connection line (ribbon cable) 2a manufactured integrally therewith.

FIG. 2 schematically depicts essential steps in the production of the laminated glass pane depicted in FIG. 1.

In a step S1, an electronic functional unit 2b and another part 2c and a prefabricated supply line 2a′ are preassembled to form a functional module structure 2′. In a step S2, the functional module structure 2′ is encapsulated with a casting compound in an insulating and mechanically protective manner and provided on both sides with an adhesive coating (not shown), thus obtaining the finished electronic functional module 2. In a step S3, a PVB film 1c′ is provided with a cutout 1d matched to the lateral dimensions of the electronic functional module 2 and yields the preconfigured PVB film 1c, as depicted in FIG. 1.

In a first step S4 of a so-called in-line process, the configured PVB film 1c and the prefabricated electronic functional module 2 are mounted on the first glass pane 1a, and in a subsequent step S5, the second glass pane 1b is placed on this preassembled assembly, and the stack is laminated in the usual manner to form the laminated glass pane 1.

The implementation of the invention is not restricted to the example explained above, but is also possible in a large number of modifications that are within the scope of the attached claims.

### LIST OF REFERENCE CHARACTERS

1 laminated glass pane

1a, 1b first and second glass pane

1c polymer film (PVB film)

1d cutout in the polymer film

2 electronic functional module

2′ functional module structure

2a integrated supply line

2a′ prefabricated supply line

2b electronic functional unit

2c part of the functional module

1. A laminated glass pane comprising two glass or polycarbonate panes and at least one polymer film or a film laminate bonded therebetween and an electronic functional unit arranged therebetween, wherein, in part of an area of the laminated glass pane, a cutout of the polymer film or of the film laminate is provided and, accommodated in the cutout, is a fully prefabricated electronic functional module comprising multiple electronic functional units and/or other parts that are arranged within the functional module laterally alongside one another and/or at least partially vertically overlapping in an electrically and mechanically protective insulating shell.

2. The laminated glass pane according to claim 1, implemented as a front window or rear window or roof glazing of a vehicle, wherein the cutout of the polymer film or of the film laminate and the prefabricated electronic functional module are arranged at or near an edge of the laminated glass pane.

3. The laminated glass pane according to claim 1, wherein a thickness of the polymer film or of the film laminate and of the electronic functional module is less than 1.2 mm.

4. The laminated glass pane according to claim 1, wherein the electronic functional module has the shape of a flat prism or of a flat circular disk.

5. The laminated glass pane according to claim 4, wherein two main surfaces of the flat prism or of the flat circular disk are coated with adhesive for bonding the electronic functional module between the glass or polycarbonate panes.

6. The laminated glass pane according to claim 1, wherein the electronic functional module comprises at least one of the following functional units: a moisture sensor, a light sensor, a temperature sensor, an antenna, an actuator, an electronic processing or switching unit, an LCD display unit, and an LED display unit.

7. The laminated glass pane according to claim 1, wherein the electronic functional module includes an integrally prefabricated electrical supply line that is accommodated in a supply line cutout of the polymer film or of the film laminate.

8. A vehicle comprising at least one laminated glass pane according to claim 1.

9. A method for producing a laminated glass pane according to claim 1, comprising:
providing a first and second glass or polycarbonate pane,
providing a polymer film or a film laminate for bonding the first and second glass or polycarbonate pane, with a cutout provided therein,
providing a fully prefabricated electronic functional module, whose cross-sectional shape is matched to a shape of the cutout in the polymer film or the film laminate and whose thickness is at most equal to a thickness of the polymer film or of the film laminate,
gluing the polymer film and placing the prefabricated electronic functional module on a surface of the first or second glass or polycarbonate pane,
placing the second glass or polycarbonate pane on the resultant composite, and
laminating the composite with the second glass or polycarbonate pane placed thereon to complete the laminated glass pane, wherein the provision of the fully prefabricated electronic functional module completes the creation of an insulating encapsulation of the functional units and/or parts contained therein.

10. The method according to claim 9, wherein the provision of the electronic functional module includes the coating of two opposite, parallel main surfaces thereof with an adhesive.

11. The method according to claim 9, wherein the provision of the fully prefabricated electronic functional module includes providing it with an electrical connection line, in particular in the form of a ribbon cable.

12. The laminated glass pane according to claim 1, wherein the mechanically protective insulating shell is an encapsulation composed of a polymeric casting compound that has a thickness that is at most equal to a thickness of the polymer film or of the film laminate.

13. The laminated glass pane according to claim 3, wherein the thickness of the polymer film or of the film laminate and of the electronic functional module is in the range between 0.6 mm and 1.0 mm.

14. The laminated glass pane according to claim 4, wherein the electronic functional module has the shape of a flat cuboid.

15. The vehicle according to claim 8, wherein the vehicle is a road vehicle.

16. The method according to claim 9, wherein the insulating encapsulation is an encapsulation with a casting compound.
